(19) United States
(12) Patent Application Publication
(10) Pub. No.: US 2018/0045169 A1
(43) Pub. Date: Feb. 15, 2018

(54) IMPROVED APPARATUS FOR EXCHANGING KINETIC ENERGY BETWEEN A FLUID AND A STRUCTURE MOVEABLE RELATIVE TO THE FLUID

(71) Applicant: HTP TECHNOLOGIES B.V., Willemstad (CW)

(72) Inventor: Johannes Willem VAN BRIEMEN, Baarn (NL)

(73) Assignee: HTP TECHNOLOGIES B.V., Willemstad (CW)

(21) Appl. No.: 15/556,157

(22) PCT Filed: Mar. 3, 2016
(86) PCT No.: PCT/NL2016/050146

§ 371 Date: Sep. 6, 2017

(30) Foreign Application Priority Data
Mar. 12, 2015 (NL) 2014441

(51) Int. Cl. F03B 17/06; B63B 35/44; B63H 19/04; F03D 3/00

(52) U.S. Cl. CPC F03B 17/067; F03D 3/005; B63B 35/44; B63H 19/04; F05B 2210/16; F05B 2220/20; F05B 2260/4031; B63B 2035/4466

(57) ABSTRACT

An apparatus for exchanging kinetic energy between a fluid and a structure moveable relative to the fluid and connected to the apparatus, including a channel enclosed by a channel wall connected with the structure, and adapted to guide the fluid, at least four identical blades moveable within the channel and being connected to an energy converter coupled with the structure.

The invention relates to an apparatus for exchanging kinetic energy between a fluid and a structure moveable relative to the fluid and connected to the apparatus, the apparatus comprising a channel enclosed by a channel wall connected with the structure, the channel wall being adapted to guide the fluid, at least four substantially identical blades extending within the channel, being moveable within the channel and being connected to an energy converter coupled with the structure, the blades each comprising two substantially identical blade parts, separated by a hinge, extending in a radial plane in each position of the blades, wherein the blades are adapted to perform a recurrent movement, in the flow direction with the main plane of the blades extend substantially perpendicular to the flow direction, and against the flow direction with the main plane of the blades extend substantially parallel to the flow direction.

Such an apparatus is disclosed in the Dutch patent application NL-A-1 039 946.

The technical implementation of this prior art apparatus is rather complicated as it comprises a substantial number of parts and joints, leading to an expensive construction which needs substantial maintenance.

The aim of the present invention is to provide such an apparatus, wherein the disadvantages of the prior art are alleviated.

This aim is reached in by an apparatus of the kind referred to above, wherein between each pair of adjacent blades a wall joint is connected to the channel wall, a hinge joint being located in the centre of each hinge, a rod extends between each wall joint and the two adjacent hinge joints and the two blade halves adjacent to a wall joint extend orthogonal in each position of the blades.

It may be advantageous to express the movement of the planes in linear algebra. In linear algebra a flat plane in space can be described by one supporting vector SV(x,y,z) and two direction vectors DV1(x,y,z) and DV2(x,y,z) wherein x, y and z represent the coordinates. By varying the length of the direction vectors with two parameters (usually λ and μ) all points on the plane can be found. This is represented in the following formula:

P(x,y,z)=SV(x,y,z)+λ.DV1(x,y,z)+μDV2(x,y,z)

The blades in the system are described by four or a larger even number of planes with mathematically determined direction vectors and supporting vectors, wherein the planes have mutually constrained relationships.

In case of six blades and twelve blade halves all adjacent planes (planes ab and cd) follow the relationship that the supporting vectors (SVab and SVcd) describe a circular orbit with an accelerated angle rotation, similar to an universal or cardan joint in a fixed angle of 30°. Their two direction vectors (DV1ab, DV2ab and DV1cd, DV2cd) are mutually related by the fact that the angle of DV1ab and DV equals 90° and the angle of DV2ab and DV2cd equals 60° during the complete rotation of 360°.

This new configuration maintains the advantages of the prior art apparatus as described in NL-A-1 039 946, but in a mechanically simpler configuration, with less parts and joints, making the construction less vulnerable for damage and requiring less maintenance.

Preferably the channel has a symmetrical cross section at the location of the blades, the blades have been arranged symmetrically in the channel and that the wall joints are evenly distributed over the circumference of the cross section of the channel. This enhancement of symmetry makes the advantages related to symmetry, such as the compensation of pressures and flows perpendicular to the main direction of flow.

To obtain an even further simplification of the construction, another preferred embodiment provides the feature that the blades halves each comprise a frame with linear bars extending to both sides of the hinges parallel to the axes of the hinges and a semi-circular guide rail connecting the distal ends of the bars, wherein a sleeve is located around each semi-circular guide rail and each sleeve is connected with a rod.

The above embodiment defines only the frame which forms the basis for the blades. A first embodiment of the blade halves is characterized in that the blade halves comprise blade sheets located at one side of the blade frames.

Additionally it is possible that the blade halves comprise blade sheets extending at both sides of the blade frames, thus enclosing the frames.

Just as in the prior art apparatus, an optimal configuration is obtained when the apparatus comprises six blades and the two rods extending from the same joint, extend under an angle of 120°. In this embodiment the blades extend over nearly the full cross-section of the channel in the position in which they (alternately) extend perpendicular to the main flow direction.

A further simplification takes place when the wall joint is a ball joint and that the two rods extending from the ball joint, are solidly connected. However this embodiment requires an alternative way for transferring the mechanical power between the apparatus according to the invention and the energy converter, as the ball joint serves only for guiding purposes.

In an alternative to the preceding embodiment, the wall joint comprises a shaft extending in the tangential direction, that the two rods are connected to the shaft by a universal joint and that the shaft is connected with the energy converter. This embodiment comprises more parts, but it is adapted to transfer mechanical power between the apparatus according to the invention and the energy converter.

An embodiment especially adapted for combination with the embodiment with a ball joint as a wall joint provides the feature that the apparatus comprises a drive shaft for each blade, the drive shaft being coupled to the energy converter and the drive shaft extending in tangential direction between the radial middle plane of the blades and that the drive shaft is connected with a crank connected to the centre of the hinge.

As stated before, the apparatus according to the invention can be used to the conversion of kinetic energy from a flowing fluid to the kinetic energy of a moving structure, but also for the conversion of kinetic energy from a moving structure to the kinetic energy of a fluid. This implies that energy conversion in two directions is possible. Often a further conversion of energy is required, such as into electrical energy or from electrical energy. Hence a preferred embodiment proposes to couple the connection elements each to a first part of an energy converter and to connect the blade parts each to the second part of the energy converter. The energy converter may be an electrical machine, which can function as a generator or as a motor allowing energy conversion in both directions. It is however also possible to This embodiment provides an integration of the electric machine into the apparatus itself, avoiding the use of electrical machines located elsewhere, and hence providing a compact structure. As stated before, an attractive application of the invention resides in the conversion of kinetic energy of flowing water to kinetic energy of a rotating shaft, which can be used for water turbines.

A similar application of the invention resides in the propulsion of ships. Hence an embodiment proposes that the apparatus is dimensioned for converting kinetic energy of a rotatable shaft into kinetic energy of vessel connected to the apparatus and that the rotatable shaft of the apparatus is connected to a combustion engine or to an electric motor.

The two applications mentioned above relate to the exchange of kinetic energy to and from water. Another application resides in the exchange of kinetic energy to and from air. A first application is in ventilators, but another, presumably more important application resides in wind turbines. Consequently a preferred embodiment provides an apparatus of the kind referred to above which is dimensioned for converting kinetic energy of wind into kinetic energy of a rotatable shaft.

Another preferred embodiment provides the feature that the rotatable shaft is coupled to an electric generator.

A major advantage resides in strong reduction of currents in the direction deviating from the main direction of flow. This implies that adjacent flows generated by the apparatus according to the invention will interfere less than before. This will not only count for situations wherein the apparatus according to the invention is used for generating flows, but also in situations wherein the kinetic energy of flows is converted into kinetic energy of a rotating shaft, wherein the lack of flows deviating from the main direction of flow will appear from the flows leaving the apparatus. This effect allows to combine a number of apparatuses in their immediate vicinity. A preferred embodiment of hence provides the feature that the rotatable shafts of the apparatuses extend mutually parallel, and that the distance between the channel walls of adjacent apparatuses is smaller than the width of the channel walls.

The apparatuses do not necessarily have to be arranged with their centres in the same plane, but due to constructional reasons it can be attractive when the blades of the apparatuses in their position perpendicular to the flow direction, extend substantially in the same plane. This allows to construct ‘energy walls’ with large numbers of apparatuses being arranged in the same structure. Such walls may be constructed in the sea, preferably in locations wherein tides provide for alternating flows, but also in locations where winds are prevailing to allow large amounts of energy to be generated by a single structure.

Of course it is possible to connect each of the apparatuses to a separate energy converter, but it is usually attractive to connect al apparatuses to the same energy converter. However when the number of apparatuses is large, it may be advantageous to divide the number of apparatuses into a number of groups wherein the apparatuses belonging to a group, are connected to the same energy converter.

Subsequently the present invention will be elucidated with the help of the following drawings wherein depict:

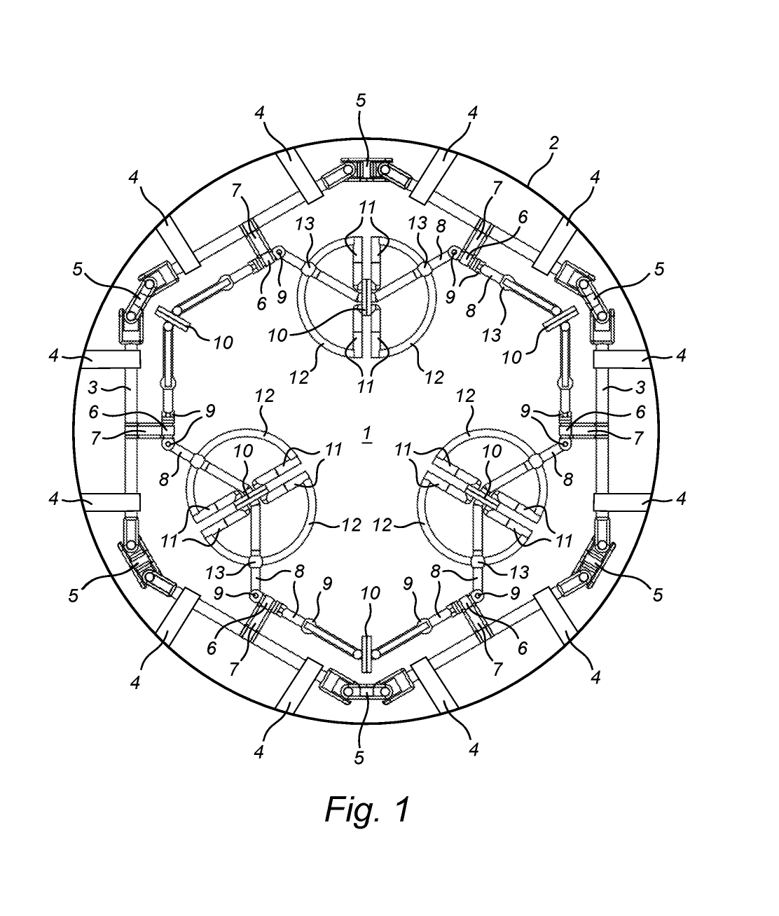

FIG. 1: a cross sectional view of an apparatus according to the invention;

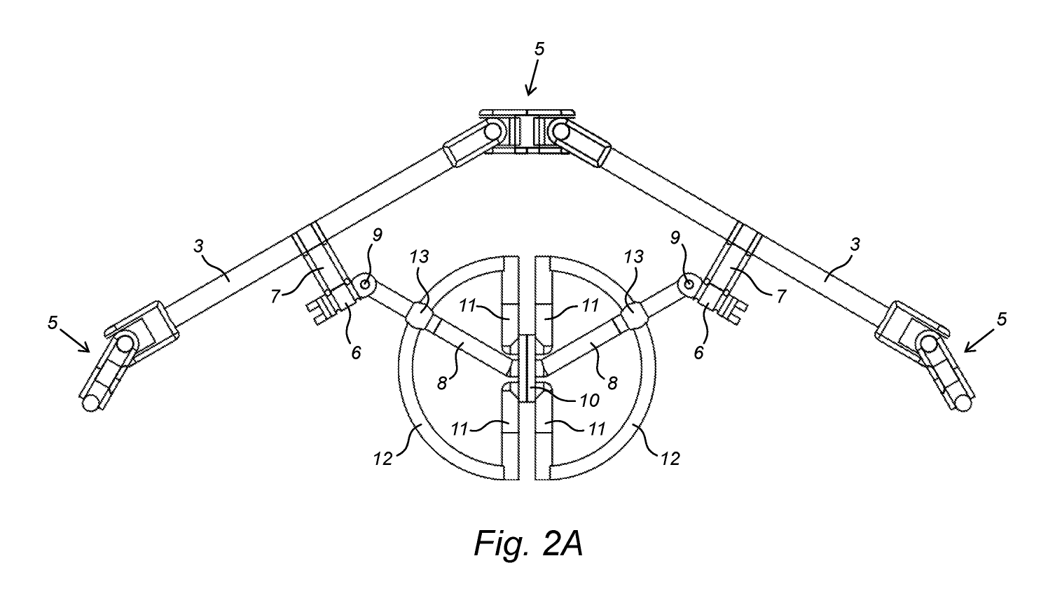

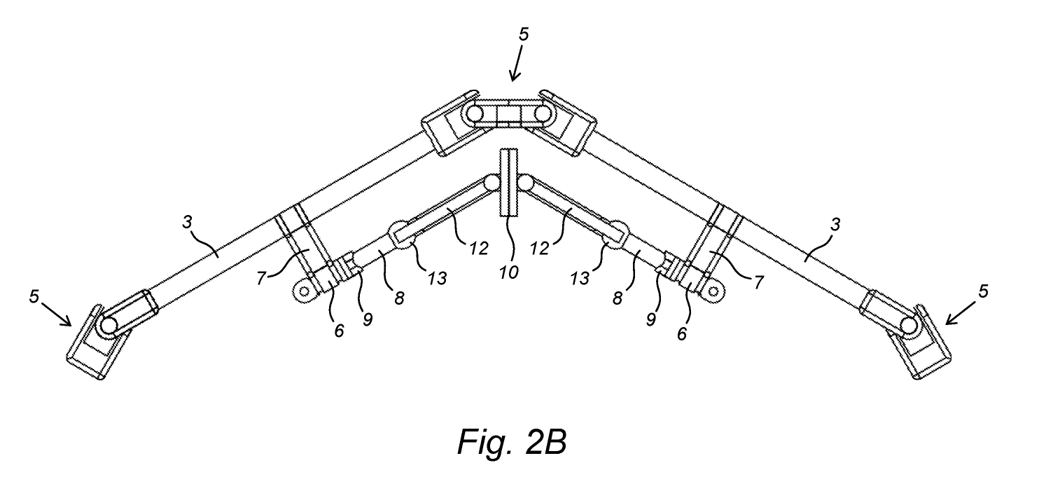

FIG. 2A: a cross sectional view of a detail of the apparatus depicted in FIG. 1;

FIG. 2B: a cross sectional view of a detail of the apparatus depicted in FIG. 1, wherein the blades have a different position;

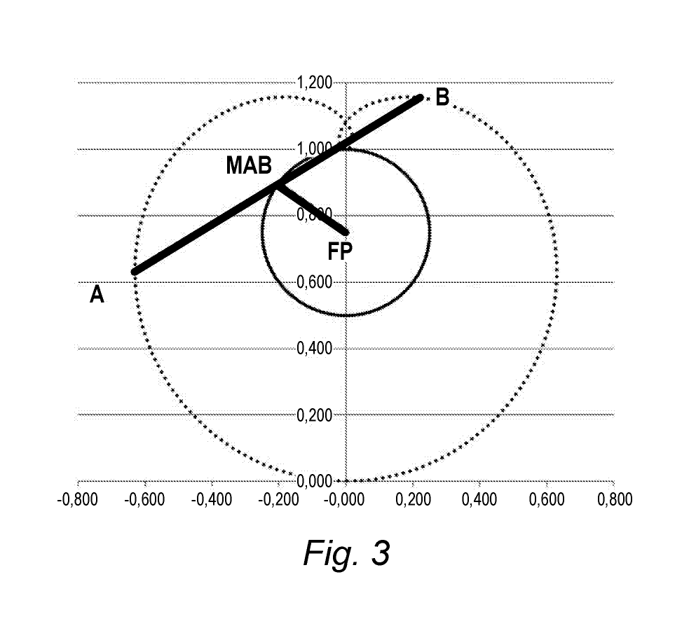

FIG. 3: a diagram showing the movement of points of the blades of the apparatus depicted in FIG. 1;

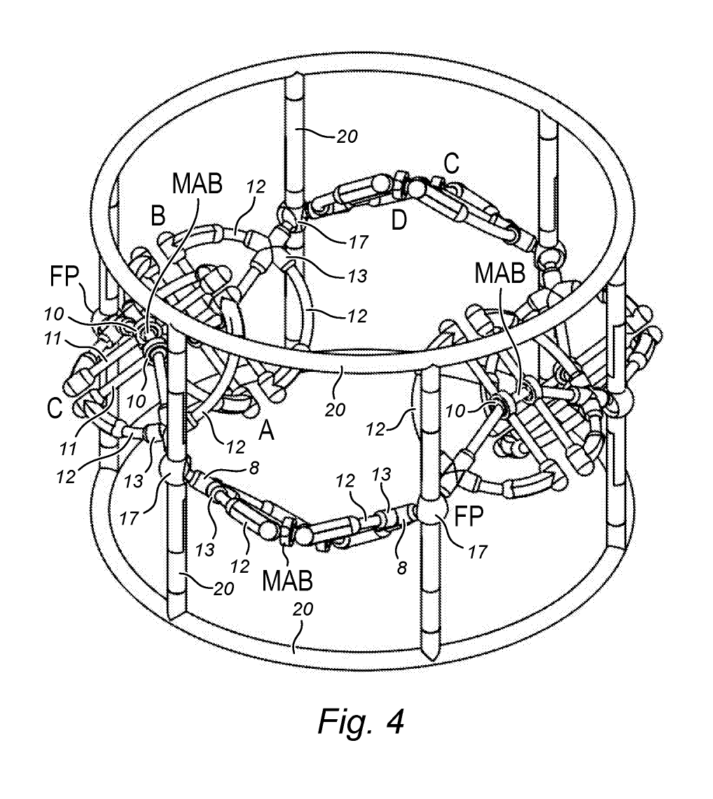

FIG. 4: a perspective view of an alternative embodiment; and

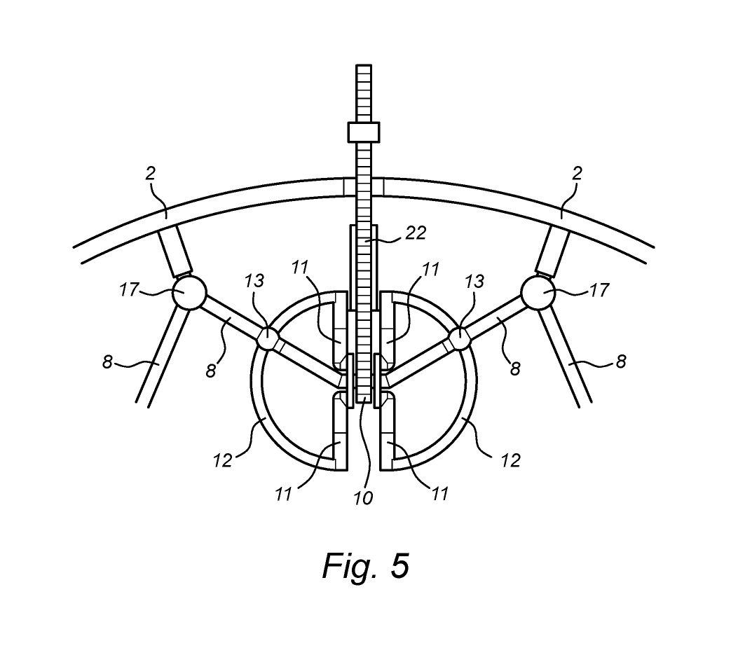

FIG. 5: a cross of the sectional view of the embodiment depicted in FIG. 4.

The apparatus according to the invention is located in a channel, preferably a cylindrical channel 1, as shown in FIG. 1. The cylindrical channel 1 is enclosed in a channel wall 2. All figure show a hexagonal configuration, which seems to be the optimal configuration, although other configurations, such as octagonal are not excluded. The hexagonal configuration of the apparatus comprises six drive shafts 3, each extending in a tangential direction in a plane perpendicular to the axial direction of the channel 1. All drive shafts are journalled in bearings 4 connected to the channel wall 2. The drive shafts are mutually connected by joints, preferably homokinetic joints 5. The apparatus further comprises connecting shafts 6 extending parallel to the drive shafts 3, and drivingly connected to the drive shafts by sets of gears 7. The connecting shafts 6 are significantly shorter than the drive shafts 3. Although not depicted in the drawings, the drive shafts 3 are coupled with an energy converter, located at the outside of the channel 1.

At each end of the connecting shafts 6, rods 8 are connected by universal joints 9. The distal ends of each pair of rods 8 are mutually connected by hinges 10. The hinges 10 comprise two leaves each, which can mutually rotate relative to a first axis extending with a radial component. In so far they are ‘normal’ hinges. The hinges further allow mutual movement of the rods over a second axis perpendicular to the first axis. Bars 11 extend from both ends of the hinges in the direction of the first axis of the hinges 10. The ends of the bars extending from the same hinge 10 are connected to a semi-circular guide rail 12. The rods are provided with sleeves 13 which surround the rods 8. The combination of a hinge half of a hinge 10, the two bars 11 connected thereto and the semi-circular guide rail 12 form a frame, of which the position is determined by the rods 8. The complete apparatus comprises twelve of these frames. Each of the frames is covered by a single blade extending at one side of the frame, or by two blades extending at either side of the frames. For clarity reasons the blades are omitted in the drawings.

It is noted that none of the figures depicts the actual blades themselves, as for reasons of clarity, the blades are omitted from the figures. Nevertheless it will be clear that the blades extend over the area covered by the hinges 10, the bars 11 and the semi-circular guides 12. The blades may extend at one side of the frame formed by the hinges 10, the bars 11 and the semi-circular guides 12 only, but that they may as well extend at both sides of these frames. Herein the latter configuration seems the most advantageous as the action of the blades will be symmetrical.

FIG. 3 shows the trajectories of several points of the centre line of a blade in a radial plane. The centre of the blade is formed by the axis of the hinges 10, extending between the distal ends of the bars 11. The ends are marked by A and B and FP denotes the centre point of this central line AB, that is the point where the rods 8 meet the hinge 10.

The centre MAB performs a circular movement around a centre FP, and the ends A and B perform a movement having a cardioid shape as shown in FIG. 4 during movement of the blades. Herein both ends move over the same path.

The apparatus thus described may perform a movement, as caused by the flow of a fluid through the channel, which acts a force on the blades. In such a case the apparatus is used for generating electricity from the flow of water or air. It is also possible that the apparatus is used for driving a vessel, in that the apparatus forms part of a vessel, the energy converter, also incorporated in the vessel, drives the blades and the blades act forces on the fluid, thus propelling the vessel.

The blades perform a complicated movement, which will be briefly discussed with the help of FIG. 4. It is noted that FIG. 4 shows a different embodiment but the movements and geometry of both embodiments are the same. There are some aspects which are better understood with the help of FIG. 4, as this figure shows the relation between the position of the different blades. All six blades 15 perform a sync movement, wherein three blades are in phase and the three other blades located between the other three are shifted in phase over 180°. In other words, adjacent blades are in counter phase. This can also be expressed by the fact that the axes of the hinges of adjacent blades extend orthogonal, which can be seen from FIG. 3. Another feature of the present invention is that the angle between rods 8 of adjacent blades is 120°. In the embodiment discussed above this not a very important feature, but it is in the embodiment to be discussed subsequently. Further the two rods 8 of the same blade 15 also extend under an angle of 120°. This implies that these rods can be mutually connected in the embodiment discussed above. Of course, this would imply that each rods must allow mutual rotation around its longitudinal axis between its mutually connected end and its end connected to the connecting shafts 6. Further this would require an elaborate construction of the hinges 10, despite the fact that the rods in a blade form one piece.

The fact that the two rods connected with adjacent blades extend under an angle of 120°, offers the possibility to form a rigid connection between these two rods. However the guiding of the connection point or joint between these rods is essential for the action of the apparatus according to the invention. Hence in an alternative embodiment, depicted in FIGS. 4 and 5, the connecting shafts 6 have been removed, together with their homokinetic joints 7 and been replaced by a guide 16 for a ball joint 17. The rods 8 are both rigidly connected to the ball of the ball joint 17 so that the two rods 8 and the ball of the ball joint 17 form a single part. Just as in the embodiment described before, the rods 8 must be able to rotate around their own axes at the connection with the hinges on the blades to allow proper functioning of the apparatus. This is best visible in FIG. 4, showing the structure of the second embodiment in perspective view. To enhance clarity the channel wall of the channel has been removed and been replaced by a grid 20, wherein the ball joints 17 are integrated. It will be clear that a channel wall will be present nevertheless.

As at the location of the ball joint 17 there is no possibility to transfer mechanical energy between the blades and the external energy converter. Hence other means must be provided to perform this function. The embodiment depicted in FIG. 4 comprises such means in the form of a wheel 21 on a shaft 22 extending in the tangential direction and located at the point FP depicted in FIG. 3. Said shaft 22 is connected with the external energy converter, possibly, as depicted in FIG. 5, via gear teeth located on the wheel 21, which teeth are in engagement with the teeth on a gear 23 on a shaft which is coupled to the energy converter. Therefore the wheel 21 is eccentrically connected with the hinge 11 and it performs the function of a crank for transmitting the rotation of the centre of the blades to the shaft 22 and further to the external energy converter.

It will be clear that numerous modifications can be made to the shown embodiments of which features may be mutually combined and that the scope is determined by the claims.

1-16. (canceled)

17. An apparatus for exchanging kinetic energy between a fluid and a structure moveable relative to the fluid and connected to the apparatus, the apparatus comprising:
a channel enclosed by a channel wall connected with the structure, the channel wall being adapted to guide the fluid;
at least four substantially identical blades extending within the channel, being moveable within the channel and being connected to an energy converter coupled with the structure, the blades each comprising two substantially identical blade parts, separated by a hinge, extending in a radial plane in each position of the blades;
wherein:
the blades are adapted to perform a recurrent movement,
in the flow direction with the main plane of the blades extend substantially perpendicular to the flow direction, and
against the flow direction with the main plane of the blades extend substantially parallel to the flow direction, wherein between each pair of adjacent blades a wall joint is connected to the channel wall;
a hinge joint being located in the centre of each hinge;
a rod extends between each wall joint and the two adjacent hinge joints; and
the two blade halves adjacent to a wall joint extend orthogonal in each position of the blades.

18. The apparatus as claimed in claim 17, wherein the channel has a symmetrical cross section at the location of the blades, the blades have been arranged symmetrically in the channel and that the wall joints are evenly distributed over the circumference of the cross section of the channel.

19. The apparatus as claimed in claim 18, wherein the blades halves each comprise a frame with a straight bars extending to both sides of the hinges parallel to the axes of the hinges and a semi-circular guide rail connecting the distal ends of the bars, wherein a sleeve is located around each semi-circular guide rail and that each sleeve is connected with a rod.

20. The apparatus as claimed in claim 17, wherein the blade halves comprise blade sheets located at one side of the blade frames.

21. The apparatus as claimed in claim 20, wherein the blade halves comprise blade sheets extending at both sides of the blade frames.

22. The apparatus as claimed in claim 17, wherein the apparatus comprises six blades and that the two rods extending from the same joint, extend under an angle of 120°.

23. The apparatus as claimed in claim 22, wherein the wall joint is a ball joint and that the two rods extending from the ball joint, are solidly connected.

24. The apparatus as claimed in claim 22, wherein the wall joint comprises a shaft extending in the tangential direction, that the two rods are connected to the shaft by a universal joint and that the shaft is connected with the energy converter.

25. The apparatus as claimed in claim 22, wherein the apparatus comprises a drive shaft for each blade, the drive shaft being coupled to the energy converter and the drive shaft extending in tangential direction between the radial middle plane of the blades and that the drive shaft is connected with a crank connected to the centre of the hinge.

26. The apparatus as claimed in claim 17, wherein the apparatus is dimensioned for converting kinetic energy of flowing water into kinetic energy of a rotatable shaft.

27. The apparatus as claimed in claim 17, wherein the apparatus is dimensioned for converting kinetic energy of a rotatable shaft into kinetic energy of vessel connected to the apparatus and that the rotatable shaft of the apparatus is connected to an internal combustion engine or to an electric motor.

28. The apparatus as claimed in claim 17, wherein the apparatus is dimensioned for converting kinetic energy of wind into kinetic energy of a rotatable shaft.

29. The apparatus as claimed in claim 27, wherein the rotatable shaft is coupled to an electric generator.

30. A combination of apparatuses as claimed in claim 17, wherein the rotatable shafts of the apparatuses extend mutually parallel, and that the distance between the channel walls of adjacent apparatuses is smaller than the width of the channel walls.

31. The combination as claimed in claim 30, wherein the blades of the apparatuses in their position perpendicular to the flow direction, extend substantially in the same plane.

32. The combination as claimed in claim 30, wherein the apparatuses are all connected to the same energy converter.
